(19) United States
(12) Patent Application Publication
(10) Pub. No.: US 2025/0068737 A1
(43) Pub. Date: Feb. 27, 2025

(54) TRUSTGPT

(71) Applicant: WINKK, INC, Menlo Park, CA (US)

(72) Inventors: Robert O. Keith, JR., San Jose, CA (US); Avtar Singh Sehra, Westminster (GB)

(21) Appl. No.: 18/813,960

(22) Filed: Aug. 23, 2024

Related U.S. Application Data
(60) Provisional application No. 63/534,697, filed on Aug. 25, 2023.

(51) Int. Cl. G06F 21/56; G06N 3/0475

(52) U.S. Cl. CPC G06F 21/566; G06N 3/0475; G06F 2221/034

(57) ABSTRACT

TrustGPT secures a device by ensuring that only an authorized user is able to use the device. TrustGPT utilizes information received from one or more sensors of the device and generative artificial intelligence to determine that the current user is the authorized user. Without TrustGPT, user devices are susceptible to being stolen or hacked and used for nefarious purposes.

### CROSS-REFERENCE TO RELATED APPLICATION(S)

This application claims the benefit of U.S. Provisional Patent Application Ser. No. 63/534,697, filed Aug. 25, 2023, and titled “TRUSTGPT,” which is hereby incorporated by reference in its entirety for all purposes.

### FIELD OF THE INVENTION

The present invention relates to security. More specifically, the present invention relates to a security architecture.

### BACKGROUND OF THE INVENTION

Although the Internet provides a massive opportunity for shared knowledge, it also enables those with malicious intentions to attack such as by stealing personal data or causing interference with properly functioning mechanisms. The Internet and other networks will continue to grow both in size and functionality, and with such growth, security will be paramount.

Mobile phones are replacing users' wallets, keys, cameras, and many other personal items. Therefore, the security of the mobile phone is very important. If a thief or hacker gains access to a user's mobile phone, they may be able to access personal information and financial information, which could leave the victim in financial ruin, make the victim susceptible to a physical attack/burglary or have their personal privacy invaded.

### SUMMARY OF THE INVENTION

TrustGPT secures a device by ensuring that only an authorized user is able to use the device. TrustGPT utilizes information received from one or more sensors of the device and generative artificial intelligence to determine that the current user is the authorized user. Without TrustGPT, user devices are susceptible to being stolen or hacked and used for nefarious purposes.

In one aspect, a method programmed in a non-transitory memory of a device comprises training a generative Artificial Intelligence (AI) system, capturing data using one or more sensor of the device and determining a trust score using one or more on-device heuristic models. The generative AI system utilizes autoregression and transformers to learn and train. The generative AI system is trained using synthetic data. The data includes movement information, video information or audio information. The data captured comprises a time series. The method further comprises generating periodic samples of the data, compressing the periodic samples and sharing the periodic samples with a server device. Determining the trust score includes predicting a next element in a sequence based on a context of previously generated elements, and when sampled points generated by the device based on the captured data do not align with predicted points from a model, the trust score is reduced. The method further comprises blocking one or more components or one or more applications on the device when the trust score is below a threshold.

In another aspect, a device comprises a non-transitory memory for storing an application, the application configured for: training a generative Artificial Intelligence (AI) system, capturing data using one or more sensor of the device and determining a trust score using one or more on-device heuristic models and a processor configured for processing the application. The generative AI system utilizes autoregression and transformers to learn and train. The generative AI system is trained using synthetic data. The data includes movement information, video information or audio information. The data captured comprises a time series. The application is further configured for generating periodic samples of the data, compressing the periodic samples and sharing the periodic samples with a server device. Determining the trust score includes predicting a next element in a sequence based on a context of previously generated elements, and when sampled points generated by the device based on the captured data do not align with predicted points from a model, the trust score is reduced. The application is further configured for blocking one or more components or one or more applications on the device when the trust score is below a threshold.

In another aspect, a system comprises a server device configured and a user device configured for: training a generative Artificial Intelligence (AI) system, capturing data using one or more sensor of the device, generating periodic samples of the data, compressing the periodic samples and sharing the periodic samples with the server device and determining a trust score using one or more on-device heuristic models. The generative AI system utilizes autoregression and transformers to learn and train. The generative AI system is trained using synthetic data. The data includes movement information, video information or audio information. The data captured comprises a time series. Determining the trust score includes predicting a next element in a sequence based on a context of previously generated elements, and when sampled points generated by the device based on the captured data do not align with predicted points from a model, the trust score is reduced. The user device is further configured for blocking one or more components or one or more applications on the device when the trust score is below a threshold.

### BRIEF DESCRIPTION OF THE DRAWINGS

FIG. 1 illustrates a set of modules in the TrustSDK according to some embodiments.

FIG. 2 illustrates a flowchart of a method of utilizing generative AI to determine a trust score of a user on a device according to some embodiments.

FIG. 3 illustrates a network of devices configured for implementing the method of utilizing generative AI to determine a trust score according to some embodiments.

FIG. 4 illustrates a block diagram of an exemplary computing device configured to implement TrustGPT according to some embodiments.

### DETAILED DESCRIPTION OF THE PREFERRED EMBODIMENT

Generative Artificial Intelligence (AI) has revolutionized various domains, including image synthesis, text generation, and music composition. The fundamental techniques employed in generative AI are autoregression and the use of transformers. Autoregression enables AI models to learn and generate data by using the concept of conditional probability, and the transformer architecture provides faster training and generation times compared to traditional autoregressive neural network approaches.

The way autoregression and transformers synergistically work together to power generative AI systems is described herein. The foundation can be applied to time series modeling and predictions. The approach for time series modeling is able to be used for predicting a user's behavior in different contexts using the data on their device(s) e.g., phone, watch and headset, and other devices.

Such a user behavior prediction model can then be used for determining the “trust” level of a user's identity in a particular context. For example, based on the context and behavior of a user, the likelihood of a user being who they say they are can be assessed when they are trying to execute a high value bank transfer on a mobile banking application. If the user's “trust” level is below a particular value, then a “challenge” can be posed by the device e.g., answering security questions and or confirming through a live interaction with a support person at the bank.

### Generative Neural Networks

Autoregression is a modeling technique that involves predicting the value of a variable based on its own previous values. In the context of generative AI, autoregression refers to the process of generating data one step at a time, where each step is conditioned on the previously generated information. The sequential generation process allows AI models to learn and capture the underlying patterns and dependencies within the training data, leading to coherent and realistic outputs.

Basic feed-forward neural networks have no memory of the input they receive and are bad at predicting what is coming next. Because a feed-forward network only considers the current input, it has no notion of order in time. It does not remember anything about what happened in the past except its training. In a Recurrent Neural Network (RNN), the information cycles through a loop. When the RNN makes a decision, it considers the current input and also what it has learned from the inputs it received previously. Long short-term memory networks (LSTMs) are an extension for RNNs, which extends the memory. Therefore, it is well suited to learn from important experiences that have very long time lags in between.

Such RNN and LSTM approaches for capturing autoregressive properties in neural networks can be extremely inefficient when training and when generating outputs during operation.

Transformers have revolutionized predictive generative AI models. Unlike traditional autoregressive models such as RNNs, transformers leverage a self-attention mechanism that enables them to capture long-range dependencies more efficiently. Transformers employ a parallel processing architecture, making them highly parallelizable and scalable, leading to faster training and generation times.

Autoregression and transformers work together in generative AI systems by combining the benefits of sequential generation and the power of transformer-based architectures. In the context of transformers, autoregression involves predicting the next element in a sequence based on the context of all the previously generated elements. The self-attention mechanism of transformers allows them to attend to all the positions in the input sequence, enabling them to capture both local and global dependencies efficiently.

To train transformer-based generative models, a large dataset with paired input-output sequences is used. During training, the model is exposed to the input sequence and conditioned on the preceding elements to predict the next output element. The parameters of the transformer are optimized using techniques such as backpropagation and gradient descent to minimize the discrepancy between the predicted output and the ground truth. Transformer models have proven to be highly effective in various generative tasks, such as language translation, image synthesis, and music composition.

Transformers bring several benefits to autoregressive generation in generative AI. Firstly, their ability to capture long-range dependencies allows for the generation of coherent and contextually consistent outputs over longer sequences. This is particularly advantageous in tasks such as text generation, where maintaining coherence across paragraphs or documents is important. Additionally, transformers facilitate parallel computation during training and generation, leading to faster and more efficient processing, enabling real-time or near-real-time applications.

### Application to Time Series

Autoregression and transformer-based architectures have enabled remarkable advancements in various domains such as natural language processing and computer vision. The key aspect of the advancement is that the combination of autoregression with transformers empowers AI systems to efficiently capture long-range dependencies, produce coherent outputs that make sense in the context they are presented.

As such there is early work that describes the use of generative AI for timeseries tasks, e.g., where transformers capture long-range dependencies across a training timeseries, which can then potentially lead to better forecasting performance compared to LSTMs.

Some of the key points covered in these works provide a strong foundation for potential future applications of generative AI in complex time series data modeling. The self-attention mechanism is a key component of transformers that allows them to learn long-range dependencies in time-series data. Positional encoding is used to encode the order of the time-series data into the transformer model. Multi-head attention allows transformers to learn multiple relationships between different parts of the time-series data. Encoder/decoder models are used to translate between sequences of data, such as from raw time-series data to a desired output format.

Furthermore, extensive experiments were conducted on a variety of time series datasets, including time series classification, short/long-term forecasting, imputation, anomaly detection, few-shot and zero-sample forecasting. The results showed that it is possible to achieve state-of-the-art or comparable performance on all these tasks using generative techniques.

The self-attention mechanism behaves similarly to Principal Component Analysis (PCA), which helps explain how transformers bridge the domain gap between natural language and time series data. This observation is an important step towards understanding the universality of a pre-trained transformer, e.g., intuitively transformers break down the complexities of real-world information into “principal components” that are used to model the information and predict following data.

### Modeling Trust

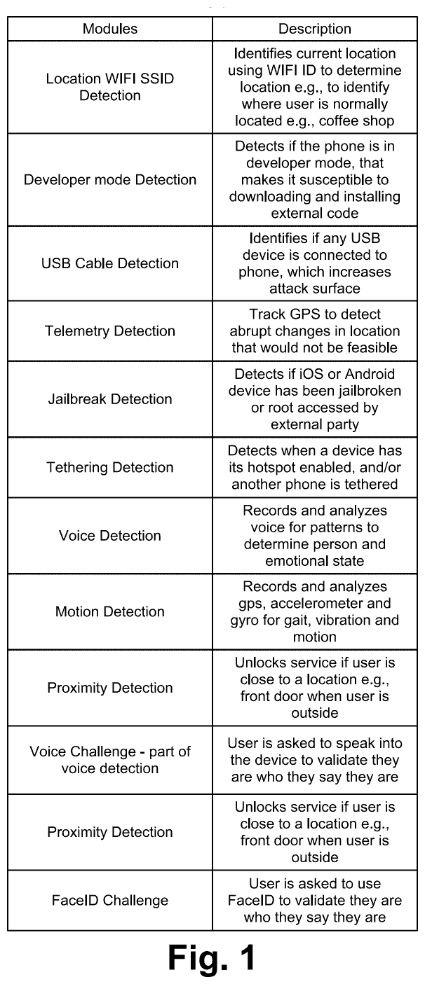

The CypherEye TrustSDK is designed to be implemented into any secure transaction application that runs on devices such as mobile devices, watches or headsets. The SDK has a number of modules, as shown in FIG. 1, which access various sensors on the device to collect and analyze data and determine a trust score for the user at that moment in time.

The data captured by device sensors takes the form of a time series, as they are collected at periodic intervals. However, the data takes different forms for each module-some are numerical (continuous or discrete) and others are categorical (yes/no or ordinal).

Furthermore, as the data is collected, it is used on the device to determine a trust score using on-device heuristic models. However, a more advanced approach is to use the data, and generate regular periodic samples, which can be compressed and shared with a central service.

This sampled data would then form a multi-dimensional multi-modal matrix. Each row of the data matrix is then a point in time, while each column would be a sampled data point from a specific module, e.g., location, voice or others.

Depending on the type of data aggregated in the combined data matrix, some of the traditional approaches for timeseries analysis that can be used on multiple series include:
1. Vector Autoregression (VAR): VAR models are a type of linear regression model that can be used to model the relationship between multiple time series. VAR models are often used for forecasting multiple time series together.
2. Vector Error Correction Model (VECM): VECM models are a type of regression model that can be used to model the long-run relationship between multiple time series. VECM models are often used for forecasting multiple time series together, but they can also be used for other purposes, such as identifying structural breaks (or anomalies) in the data.
3. Multivariate Adaptive Regression Splines (MARS): MARS models are a type of non-linear regression model that can be used to model the relationship between multiple time series. MARS models are often used for forecasting multiple time series together, but they can also be used for other purposes, such as identifying non-linear relationships in the data.

Using any of these traditional statistical time series approaches involves a complex process of model selection, fitting and optimization, which includes updates as new scenarios are identified. This means that while a lot of time and effort would be spent on setting up the modeling and prediction infrastructure, additional operations would be used to ensure models can be kept updated and calibrated. This makes traditional statistical approaches more costly to maintain and less easily adaptive to new scenarios.

A more adaptive approach can be devised, which includes a centralized generative AI model that is able to understand the next timestep in the matrix and predict the most likely set of sampled data points across the different modules based on the current state and historical context.

Therefore, if the actual sampled points being generated by the user's device do not align with the predicted points from the model, the trust score can be reduced. If this approach is being run in realtime, then as new actual and predicted sample points are being generated at the same time, the divergence (or convergence) of the predicted and actual sampled points can be used to estimate a realtime trust score and understand how the score is changing based on the scenario e.g., is the trust increasing or decreasing.

### Synthetic Training Data

Traditional AI models are trained to classify or predict specific features, so they are trained on existing data to make deductions about new data, e.g., they are not generating new content but trying to make sense of new content.

On the other hand, generative AI models are trained to generate new outputs, such as text and images. This means that they are exposed to a wide variety of examples of the type of output they are trying to generate. For example, a generative AI model that is trying to generate text is trained on a large dataset to ensure the “autoregressive” structure of the language can be modeled, including across different genres, styles, and topics. On the other hand, traditional AI approaches are more focused on a specific style or type of problem, hence the data requirements can be much smaller.

Therefore, the use of generative AI is highly dependent on a large amount of well-structured data. In the case of CypherEye, where the objective is to generate module data, such as GPS, accelerometer, gyroscope and others, this means to train such a generative AI model a large amount of similar data is used. This poses a number of challenges, which includes generating and aggregating such large volumes of data over a period of time and over different contexts.

As accessing and aggregating a large and varied amount of such data would be challenging, one approach for producing a training set would be the use of synthetic data. Synthetic data for GPS, accelerometer, gyroscope, as well as for other modules of the TrustSDK, is a powerful approach to establish the volume and variety of training data. A summary of the advantages of using synthetic data is as follows.

Real-world data can be expensive and time-consuming to collect, especially for rare or difficult-to-measure events. Synthetic data can be generated quickly and easily, and it can be tailored to specific needs.

Real-world data is often biased towards certain types of events or environments. Synthetic data can be used to create a more diverse dataset, which can help to improve the performance of the models.

Synthetic data can be used not only for the training but to test the robustness of the models to different types of input data. This can help to identify and address potential problems with the model, before it is deployed.

There are a number of different approaches to synthetic data generation for the TrustSDK modules. One common approach is to use Generative Adversarial Networks (GANs). GANs are a type of machine learning model that can be used to generate realistic synthetic data. Another approach is to use physical simulation models. Physical simulation models can be used to generate synthetic data that is based on real-world physical principles-used in the world of engineering.

The choice of approach depends on the specific needs. For example, GANs are a good choice for generating data that is similar to real-world data, e.g., the data follows specific patterns, while physical simulation models are a good choice for generating data that is based on real-world physical principles, e.g., data for new scenarios can be modeled where the underlying pattern has not previously been seen. There are a number of different tools that can be used to generate synthetic data across these two categories:

GAN models:
1. TensorFlow GAN: TensorFlow GAN is a popular GAN framework that is developed by Google.
2. PyTorch GAN: PyTorch GAN is another popular GAN framework that is developed by Facebook.

Physical simulation models:
1. Bullet Physics: Bullet Physics is a popular physics engine that can be used to simulate the motion of objects.
2. SimPy: SimPy is a Python library that can be used to simulate the behavior of systems.

In addition to modeling different movement data from accelerometers and gyroscopes using the above tools, other tools enable location data to be simulated, which can be combined with maps APIs for telemetry module training. An example tool for modeling large amounts of GPS data and aligning with real world location for telemetry training, is the location data simulator by Amazon.

### IDTrust and TrustGPT Use Cases

Included herein is a table of the various modules that are used as inputs, which provides more granular detail compared to FIG. 1, and highlights where there are additional patents already in place with IDTrust SDK e.g., the source of data collection from devices.

The following set of ID Trust analytics functions can be selected strategically to provide specific value and features for the customer's product and can also feed into the Trust GPT service. The functions listed can be enabled by selecting one or more plugin modules.

Sound analytics include: voice analytics, voice print, voice quality, word and sentence analysis. Voice print includes standard voice print identity analysis embedded into the user's device. Voice quality includes voice fry, frequencies and other voice phonatory and resonator characteristics. Analysis of word selection and sentence structures includes both user identity and mood characteristics.

Sound analytics also includes: ambient sound analytics, common sounds, sound triggers and typing sound. The common sounds function listens to background sounds and uses this information to downstream modules for more advanced analytics. Sound triggers include recurring sounds that can be defined to trigger more advanced modules. Typing sounds are the sounds of the user typing which can further identify users, especially on devices which do not have the rich set of sensors as smartphones.

Sound analytics includes: breath analytics, sleep analytics, snore and breathing anomalies and speaker proximity. A user's identity as well as a user's active possession can be determined by monitoring a user's breathing sounds. Monitoring and analysis of breath including breathing issues such as breathing problems and performance can be performed. The distance a user is in proximity to the ID trust enabled device can be determined and used to determine a device is in his possession.

Motion analytics includes activity identification, gait-based identity, device usage, motion determinations, respiration analysis, and micro vibrations. Motion analytics can determine the user's movement activities such as walking, sitting, driving, standing, and others. This provides input to downstream modules. Gait-based identity includes user identity based on gait analysis. Device usage includes how the user holds the phone, the angle, the motions during typing and general usage. Primitive motion determinations are identification of primitive motions based on movement patterns of pulses, bounces, and other and the gravity vectors. Respiration analysis uses device sensors which are sensitive enough to record human respirations and other bodily functions. Micro vibrations include detecting unique motion vibrations which can uniquely and quickly identify the users.

Video analytics includes facial identity, car analysis, health analysis, and common sights. A built-in module is able to be used for standard facial identity. Pre-Auth-car analysis is a background function, valuable for user identity during phone calls. Pre-Auth-partial face is a background automatic function fallback when the current identity trust score is low. Health analysis is able to identify many conditions directly from an image including mood, physical health symptoms, and others. Common sights is a background function which functions similar to location modules by cataloguing common sights available to the device camera.

Writing analytics include word and sentence identity, typing and swiping analytics, and health parameters. Word and sentence identity includes identifying a user not by voice but by written communications based on sentence structures and word selections. Typing and swiping analytics function monitors the user's activities while using the device such as typing texts, emails or using the various device user interface functions. This data can uniquely identify the user. Health parameter determinations are able to be based on written communications. Many health and mood statuses can be determined by various sentence patterns like word and phrase usage and changes in the users writing over a period of time.

Location analytics include common network and GPS locations and policy-based location authorization. The overall security position of the user's system can be determined by analyzing the user's movement patterns and locations. Policy-based location authorization allows the customer to define authorized locations before allowing authentication transactions.

Device platform security posture includes tethering detection, jailbreak detection, and telemetry detection. A set of modules are able to be used for analyzing whether the user device has been compromised. Tethering detection analysis determines insecure conditions such as attached insecure devices or file systems. Jailbreak detection involves various modules detecting if the device has been hacked, has insecure apps or plugins, and others. Telemetry detection is detection of insecure conditions based on external factors such as environment, location, and others.

As described, many modules are able to be used separately or in conjunction to determine a trust score for a user. For example, instead of or in addition to biometric identification (e.g., fingerprint matching) and facial/voice recognition, other aspects of a user or a user's actions are able to be analyzed (e.g., behavior or behavioral analysis). For example, a user's gait/stride, how the user uses his device, how the user types/swipes, and other motions/actions/transactions are able to be analyzed, compared and matched to determine if the user is the expected/appropriate user. Furthering the example, if a user typically takes short strides while using the phone and uses two thumbs to input text, then when a second user attempts to use the phone but has longer strides and uses a single finger input, then the device is able to detect that the person using the device is not the expected user (e.g., owner of the mobile phone).

A user device (e.g., mobile phone) is able to be used for ID proofing, where the user device recognizes a user based on various actions/input/behavioral/usage patterns (e.g., voice/facial recognition, stride/gait, location, typing technique, and so on). In some embodiments, potential user changes are detected. For example, if a user logs in, but then puts the device down, another user may pick up the phone, and is not the original user. Therefore, actions/situations such as putting the phone down, handing the phone to someone else, leaving the phone somewhere are able to be detected. Detecting the actions/situations is able to be implemented in any manner such as using an accelerometer to determine that the phone is no longer moving which would indicate that it was put down. Similarly, sensors on the phone are able to determine that multiple hands are holding the phone which would indicate that the phone is being handed to someone else. In some embodiments, the user device is configured to determine if a user is under duress, and if the user is under duress, the trust score is able to be affected. For example, an accelerometer of the user device is able to be used to determine shaking/trembling, and a microphone of the device (in conjunction with a voice analysis application) is able to determine if the user's voice is different (e.g., shaky/trembling). In another example, the camera of the user device is able to detect additional people near the user and/or user device, and if the people are unrecognized or recognized as criminals (e.g., face analysis with cross-comparison of a criminal database), then the trust score drops significantly (e.g., to zero).

A challenge is able to be implemented to verify/re-authorize the user. The challenge is able to include biometrics, a password request, a question challenge, favorite image selection, facial recognition, 3D facial recognition, movement recognition and/or voice recognition. In some embodiments, the device performs behavioral analytics as described herein to determine if the user is the owner/designated user of the device. For example, analysis is performed on the user's movements of the device, touch/typing techniques, gait, and any other behaviors. Based on the behavioral analytics, the trust score may rise. For example, if the behavioral analytics match the user's behaviors, then the trust score will go up, but if they do not match, it is determined that the device is being used by someone other than the user, and the trust score stays low or goes down. In some embodiments, the challenge enables initial access to the device, but the user's trust score starts low initially (e.g., 50 out of 100), and then based on behavioral analytics, the trust score rises.

Biometric analysis is able to be implemented as described herein and include analyzing: fingerprints, hand scans, vein patterns, iris scans, facial scans, 3D facial scans, heart rhythm, car identification and others, and behavioral analysis is able to include analysis of information such as voice tenor and patterns, gait, typing style, web page selection/usage and others. For example, the device utilizes sensors, cameras, and/or other devices/information to scan/acquire/capture biometric and/or behavioral information for/from the user. The biometric/behavioral analysis is able to include comparing acquired information (e.g., fingerprints) with stored information (e.g., previously acquired fingerprints) and determining how close the information is and whether there is a match. Any implementation of comparison/matching is able to be implemented.

In some embodiments, a biometric/behavioral challenge/Turing test is implemented. For example, a user is requested to turn his head a certain direction or look a certain direction. Furthering the example, the user is prompted by the device to look up and then look right, and the camera of the device captures the user's motions and analyzes the user's motions using video processing implementations to determine if the user looked in the correct directions. In another example, voice recognition is able to be implemented including asking a user to repeat a specific, random phrase (e.g., a random set of word combinations such as “kangaroo, hopscotch, automobile”). The vocal fingerprint and the pattern of how a user talks are able to be analyzed. For example, the device/system is able to detect computer synthesized phrases by detecting changes in pitch, odd gaps (or a lack of gaps) between words, and other noticeable distinctions. Other actions are able to be requested and analyzed as well such as requesting the user to skip, jump, walk a certain way, and so on.

In some embodiments, the biometric/behavioral challenge/Turing test is related to the biometric/behavioral analysis (e.g., in the same class/classification). For example, if the biometric/behavioral test involves facial recognition, then then the biometric/behavioral challenge/Turing test is related to facial recognition such as requesting the user to turn his head in one or more specific directions. In some embodiments, the challenge/test is unrelated to the biometric/behavioral analysis (e.g., in a different class/classification). For example, if there is a concern that a user's facial recognition information has been compromised (e.g., detection of the same facial information within a few minutes in two different parts of the world), then the challenge/test is something unrelated to that specific biometric/behavioral analysis. Furthering the example, instead of asking the user to look a specific direction, the user is requested to speak a randomly generated phrase/sequence of words or to perform an action (e.g., jump, specific exercise). Exemplary classes/classifications include a facial/head class, a gait class, a speech/voice class, a typing class, and others.

The device utilizes sensors, cameras, and/or other devices/information to scan/acquire/capture biometric and/or behavioral information for/from the user to perform the challenge/Turing test. For example, the sensors/cameras capture user information and compare the user information with stored user information to determine if there is a match. In some embodiments, computer learning is able to be implemented to perform the analysis. For example, using computer learning, the analysis/matching is able to be implemented on possible iterations that were not specifically captured but are able to be estimated or extrapolated based on the captured information. In some embodiments, the challenge/Turing test is only implemented if the user passes the biometric/behavioral analysis. In some embodiments, the device (e.g., mobile phone) implements the analysis and challenge/test steps, and in some embodiments, one or more of the steps (or part of the steps) are implemented on a server device. For example, the device acquires the biometric and/or behavioral information which is sent to a server device to perform the analysis of the acquired biometric/behavioral information. Similarly, a response by a user to the challenge/Turing test is able to be acquired by a user device, but the acquired information is able to be analyzed on the server device.

Depending on the analytics and/or challenges, the sensor data is able to include movement data such as vibration detection by the sensors, and/or shaking movement, gait motion; input data such as swiping motions and/or keyboard/keypad input; voice/audio input; image/video input; and/or any other sensor/input data.

Exemplary modules are able to be categorized such as: human movements, static image analysis, dynamic image analysis, voice print analysis, user location, external factors, device usage, and/or device internals. Human movements include a shake test, a gait test, micro-tremors, a pickup, and/or a handoff. Static image analysis includes facial recognition, ear shape, face with Turing test (e.g., user instructed to look up), and/or face with user ID (e.g., user face while holding up driver license). Dynamic image analysis includes continuous facial analysis and/or lip movement analysis. Voice print analysis includes continuous voice recognition and/or voice with a Turing test (e.g., the device instructs a user to say random words to thwart malware or recordings of the user's voice). User location includes movement vector analysis (e.g., user is on common routes), common locations (e.g., user is at home or work is more trusted than somewhere the user has never visited) and/or speed analysis (e.g., impossible travel scenarios). External factors include ambient light and/or altitude/temperature/barometric pressure. Device usage includes typing/swiping analysis, app usage analysis, and/or device login/startup. Device internals include device hardware anomalies and/or device software anomalies.

As described herein, sound processing, image/video processing, sensor processing (e.g., motion analysis), and/or other processing is able to be implemented. The analysis is able to be used to separate information into specific pieces of information to be compared and/or classified. For example, if a device captures information while a user is running, the information captured is able to include GPS information, time information, breath information, grunting noises, gait, arm motions, perspiration information, body temperature, heart rate, and many other separate pieces of information which are able to be classified. As described herein, machine learning is also able to be implemented to perform the analysis. For example, pattern matching is able to be implemented by repeatedly processing information and learning to detect patterns.

Behaviors of components of a device are monitored/analyzed by the device. Device behaviors include: CPU usage, CPU performance, network activity (uploads/downloads), storage (space remaining, change in space remaining, rate of change), operating system processes/applications, sensors (e.g., heat), and/or any other device component behaviors. For example, CPU usage includes analyzing how often the CPU is used, for how long, and what percentage of the CPU's bandwidth is used. CPU performance determines how effectively the CPU is used and if there is a process that is causing a bottleneck in one or more of the components of the CPU that is causing the CPU to slow down. Network activity is able to include uploads and downloads, the speed at which data is uploaded or downloaded, and the amount of data being uploaded or downloaded. Additionally, the sites that the device is communicating with are able to be analyzed (e.g., blacklist/whitelist). Storage analysis is able to be performed such as how much storage space is available, and is a current activity causing the available storage space to decrease (or in particular, decrease at a certain rate). Operating system processes/applications are able to be monitored and analyzed such as the amount of processing bandwidth being consumed and any changes to the system being made by the processes/applications. For example, the CPU bandwidth that a process consumes is analyzed. In another example, an application deleting stored files is monitored. Data from sensors of the device is able to be recorded and analyzed. For example, a heat/temperature sensor monitors the CPU temperature to prevent overheating. In addition to individual components being monitored and analyzed, the interaction of the components is able to be analyzed. For example, the CPU, storage and OS processes are all analyzed together, in addition to being analyzed separately.

Situational, biometric/behavior, environmental and/or other information is able to be acquired. The situational information is able to be acquired in any manner such as by: using the microphone/camera of the device, accessing the user's schedule/calendar, accessing Internet data, accessing application data, and/or another manner. For example, when a user makes a phone call using the phone app on the mobile phone, the application information is able to be acquired. In another example, a user's calendar information is able to be analyzed based on the current time to determine that the user is currently speaking at a meeting or providing a speech.

As described herein, a user's biometric and behavior information is able to be acquired when the user utilizes the device. For example, when the user walks, the user's arm movements, microtremors, and gait information are able to be acquired, and when the user performs another activity, the specific motions and details are able to be acquired using the sensors and/or components of the device. The biometric/behavior data is able to be acquired using a wearable device such as a smart watch which is able to acquire a user's heart rate and/or other physical information.

Biometric information such as a face scan, 3D face scan, ear scan, fingerprints and/or other information is able to be acquired while a user is talking. For example, if the user's voice is detected via a microphone, a camera of a device is able to be directed at the user's face, ear, or other body part to acquire facial information for a facial scan to further confirm that the user is the authorized user.

The environmental information is able to be acquired in any manner such as by: using the microphone/camera of the device, using sensors of the device (e.g., a temperature sensor), accessing Internet data (e.g., weather web site), accessing application data, and/or another manner.

The following are potential application use cases which use the above primitive behavioral analytic modules. In marketing/sales, a sales deals management analyzes customer moods and attitudes for sales presentations and sales motions to better close deals.

In mental and physical health analysis, personality trait analysis is able to be performed such that multiple behavioral or biometric factors can be used in combinations to determine a user's personality traits including mental health issues and disorders. User mood detections include detecting multiple user behaviors to derive a user's mood. This provides input data for downstream modules. A health therapy training and feedback app is a general health monitor which can provide deep analysis for physical and mental health and provide therapeutic feedback. Sleep apnea is able to be determined and diagnosed from breathing analysis modules.

Mobile app extended features use advanced augmented and virtual environments such that the CypherEye behavioral analytics can extend augmented realities for participants in virtual realms.

In social media, public deliberation digest generation includes a system which uses the ChatGPT features to scrape through various discussion sources and generate normalized answers. This would be valuable for deriving dynamic answers for controversial topics which would be discussed through public deliberation discussion forums. Virtual and augmented reality device user authentication includes realtime behavioral analysis and visual feedbacks of the analysis in the virtual spaces.

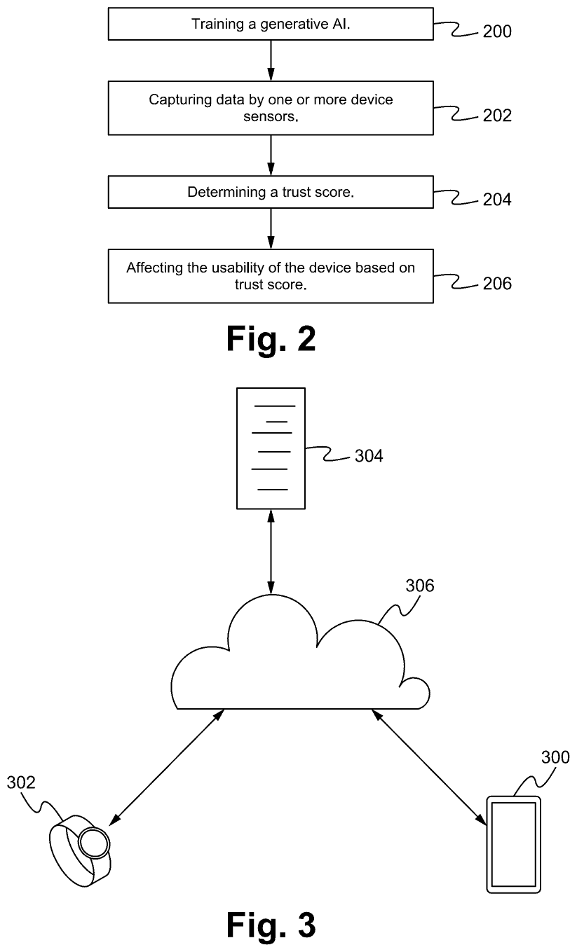

FIG. 2 illustrates a flowchart of a method of utilizing generative AI to determine a trust score of a user on a device according to some embodiments. In the step 200, a generative AI system is trained. The generative AI system is able to be implemented in any manner such as one or more applications. The generative AI system utilizes autoregression and transformers which enables the AI models to learn and generate data and perform faster training. Transformers implement a parallel processing architecture. In some embodiments, the generative AI system is trained using synthetic data. The synthetic data is able to be generated in any manner such as via GANs or a physical simulation model.

In the step 202, data is captured by one or more device sensors. For example, movement information is captured by accelerometers; video information is captured by a camera; audio information is captured by a microphone; or micro vibrations are captured by device sensors. The data captured takes the form of a time series, as the data is collected at periodic intervals. The data is able to be dependent on the module (e.g., numerical—continuous or discrete; or categorical—yes/no or ordinal).

In the step 204, as the data is collected, it is used to determine a trust score using on-device heuristic models. In some embodiments, regular periodic samples of the data are generated, compressed and shared with a central device. The generative AI model predicts a most likely set of sampled data points across different modules based on a current state and historical context. Time series modeling is used to predict a user's behavior using data from a user device. Autoregression involves predicting a next element in a sequence based on the context of all the previously generated elements. If the sampled points being generated by the user's device based on the captured data do not align with the predicted points from the model, the trust score is reduced (e.g., drops by X number of points or is reduced by Z percentage). In realtime, as new actual and predicted points are generated at the same time, the divergence or convergence of the predicted and actual points are used to estimate a realtime trust score.

The trust score is able to be generated by analyzing the acquired user information. For example, an application records (and learns) how a user types and compares how the current input with previous input and predictions to determine similarities. Similarly, the application is able to analyze a user's stride (long, short, fast, slow) by capturing the data over periods of time for comparison purposes. The trust score is also able to be based on other information such as location, time, device information and other personal information. For example, if the device is determined to be in Mexico, and the user has never visited Mexico previously, the trust score is able to be decreased. Or if the device is being used at 3a, when the user does not use the device after 10p or before 6a, then the trust score is decreased.

In the step 206, usability of the device is affected by the trust score. For example, if the trust score is below a minimum threshold, the user may be prevented from doing anything on the device, or the user is presented a challenge which may boost the trust score. Furthering the example, components of the device are locked or shut down if the trust score is below a threshold. Similarly, applications or accounts are block, locked or inaccessible if the trust score is below a threshold. In another example, if the user's trust score is determined to be below an upper threshold, the user may be permitted to utilize apps such as gaming apps, but is not able to use the device to make purchases, sign documents or login to social media accounts. If the user's trust score is above the upper threshold, the user has full access to the device and is able to perform any transaction or function. In some embodiments, actions/transactions are classified into classes or levels, and the classes/levels correspond to ranges of trust scores or being above or below specified thresholds.

In some embodiments, fewer or additional steps are implemented. In some embodiments, the order of the steps is modified.

TrustGPT is able to prove/guarantee a user is who they claim to be. Instead of or in addition to biometric identification (e.g., fingerprint matching) and facial/voice recognition, other aspects of a user or a user's actions are able to be analyzed. For example, a user's gait/stride, how the user uses his device, how the user types/swipes, and other motions/actions/transactions are able to be analyzed, compared and matched using generative AI to determine if the user is the expected/appropriate user. Furthering the example, if a user typically takes short strides while using the phone and uses two thumbs to input text, then when a second user attempts to use the phone but has longer strides and uses a single finger input, then the device is able to detect that the person using the device is not the expected user (e.g., owner of the mobile phone).

A trust score is able to be generated based on the analysis. For example, as more matches are made (e.g., valid biometric input, matching stride, and matching typing performance, the trust score increases). Policies are able to implemented based on the trust score. For example, one or more thresholds are able to be utilized such that if the trust score is below a threshold, then options are limited for that user. Furthering the example, if a user has a 99.9% trust score, then there are no limitations on the user's use of the device, but if the user has a 98.9% trust score, below a money threshold, then the user is not able to perform any transactions involving money with the device, and if the user has a 98.1% trust score, the user is not able to access any applications of the device. Any number of thresholds are able to be used, and any limitations/consequences are able to be implemented based on the thresholds/trust score.

FIG. 3 illustrates a network of devices configured for implementing the method of utilizing generative AI to determine a trust score according to some embodiments. User devices such as a mobile phone 300 or a smart watch 302 include various sensors and devices such as accelerometers, cameras, microphones, heart monitors and any other sensor/device. The sensors and devices are able to acquire data such as movements, videos, sounds. The data is then able to be processed as described herein by the generative AI system. The generative AI system is able to be stored locally on the user device and/or on a server device 304. The data is able to be communicated to the server 304 via a network 306. For example, if the server 304 processes the data, then the user device (e.g., mobile phone 300 or smart watch 302) acquires the data and transmits the data to the server 304 via the network 306. The network is able to be any network such as a LAN, WAN, the Internet, a wired network, a wireless network, a cellular network, a satellite network, and or any other network or a combination thereof.

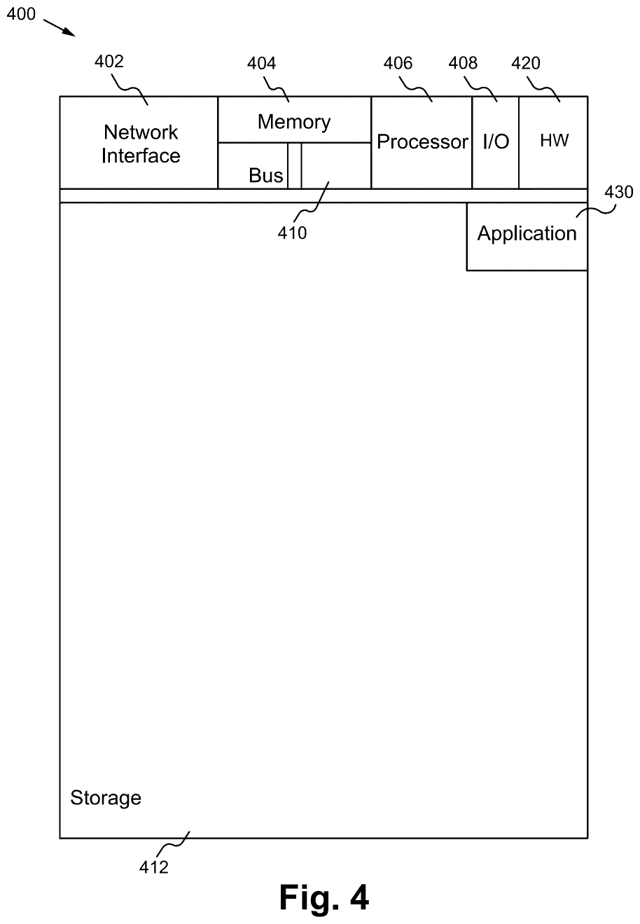

FIG. 4 illustrates a block diagram of an exemplary computing device configured to implement TrustGPT according to some embodiments. The computing device 400 is able to be used to acquire, store, compute, process, communicate and/or display information. The computing device 400 is able to implement any of the TrustGPT aspects. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. TrustGPT application(s) 430 used to implement TrustGPT are likely to be stored in the storage device 412 and memory 404 and processed as applications are typically processed. More or fewer components shown in FIG. 4 are able to be included in the computing device 400. In some embodiments, TrustGPT hardware 420 is included. Although the computing device 400 in FIG. 4 includes applications 430 and hardware 420 for the TrustGPT, the TrustGPT is able to be implemented on a computing device in hardware, firmware, software or any combination thereof. For example, in some embodiments, the TrustGPT applications 430 are programmed in a memory and executed using a processor. In another example, in some embodiments, the TrustGPT hardware 420 is programmed hardware logic including gates specifically designed to implement the TrustGPT.

In some embodiments, the TrustGPT application(s) 430 include several applications and/or modules. In some embodiments, modules include one or more sub-modules as well. In some embodiments, fewer or additional modules are able to be included.

In some embodiments, the TrustGPT hardware 420 includes camera components such as a lens, an image sensor, and/or any other camera components.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle), IoT devices or any other suitable computing device.

To utilize TrustGPT, a user device acquires user information while the user uses the device. The user information is acquired based on sensors and other devices within the user device. The user information acquired includes movement information, video information, audio information, and other information. Generative AI uses acquired user information to determine if the user is the authorized user, including generating and modifying a trust score.

In operation, TrustGPT secures a device by ensuring that only an authorized user is able to use the device. TrustGPT utilizes information received from one or more sensors of the device to determine that the current user is the authorized user. Without TrustGPT, user devices are susceptible to being stolen or hacked and used for nefarious purposes.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
training a generative Artificial Intelligence (AI) system, wherein the generative AI system utilizes autoregression and transformers to learn and train;
capturing data using one or more sensor of the device including capturing biometric data or behavioral data; and
determining a trust score using one or more on-device heuristic models.

2. The method of claim 1 wherein the generative AI system is trained using synthetic data.

3. The method of claim 1 wherein the data includes movement information, video information or audio information.

4. The method of claim 1 wherein the data captured comprises a time series.

5. The method of claim 1 further comprising generating periodic samples of the data, compressing the periodic samples and sharing the periodic samples with a server device.

6. The method of claim 1 wherein determining the trust score includes predicting a next element in a sequence based on a context of previously generated elements, and when sampled points generated by the device based on the captured data do not align with predicted points from a model, the trust score is reduced.

7. The method of claim 1 further comprising blocking one or more components or one or more applications on the device when the trust score is below a threshold.

8. The method of claim 1 wherein the behavioral data comprises a shaking motion, a gait motion, micro-tremors, device pickup, and/or device handoff.

9. The method of claim 1 wherein the biometric data comprises fingerprint data and facial/voice data.

10. A device comprising:
a non-transitory memory for storing an application, the application configured for:
training a generative Artificial Intelligence (AI) system, wherein the generative AI system utilizes autoregression and transformers to learn and train;
capturing data using one or more sensor of the device including capturing biometric data or behavioral data; and
determining a trust score using one or more on-device heuristic models; and
a processor configured for processing the application.

11. The device of claim 10 wherein the generative AI system is trained using synthetic data.

12. The device of claim 10 wherein the data includes movement information, video information or audio information.

13. The device of claim 10 wherein the data captured comprises a time series.

14. The device of claim 10 wherein the application is further configured for generating periodic samples of the data, compressing the periodic samples and sharing the periodic samples with a server device.

15. The device of claim 10 wherein determining the trust score includes predicting a next element in a sequence based on a context of previously generated elements, and when sampled points generated by the device based on the captured data do not align with predicted points from a model, the trust score is reduced.

16. The device of claim 10 wherein the application is further configured for blocking one or more components or one or more applications on the device when the trust score is below a threshold.

17. The device of claim 10 wherein the behavioral data comprises a shaking motion, a gait motion, micro-tremors, device pickup, and/or device handoff.

18. The device of claim 10 wherein the biometric data comprises fingerprint data and facial/voice data.

19. A system comprising:
a server device configured; and
a user device configured for:
training a generative Artificial Intelligence (AI) system, wherein the generative AI system utilizes autoregression and transformers to learn and train;
capturing data using one or more sensor of the device including capturing biometric data or behavioral data;
generating periodic samples of the data, compressing the periodic samples and sharing the periodic samples with the server device; and
determining a trust score using one or more on-device heuristic models.

20. The system of claim 19 wherein the generative AI system is trained using synthetic data.

21. The system of claim 19 wherein the data includes movement information, video information or audio information.

22. The system of claim 19 wherein the data captured comprises a time series.

23. The system of claim 19 wherein determining the trust score includes predicting a next element in a sequence based on a context of previously generated elements, and when sampled points generated by the device based on the captured data do not align with predicted points from a model, the trust score is reduced.

24. The system of claim 19 wherein the user device is further configured for blocking one or more components or one or more applications on the device when the trust score is below a threshold.

25. The system of claim 19 wherein the behavioral data comprises a shaking motion, a gait motion, micro-tremors, device pickup, and/or device handoff.

26. The system of claim 19 wherein the biometric data comprises fingerprint data and facial/voice data.
